(19) United States
(12) Patent Application Publication
(10) Pub. No.: US 2013/0002562 A1
(43) Pub. Date: Jan. 3, 2013

(54) VIRTUAL KEYBOARD LAYOUTS

(75) Inventors: Jyrki Veikko LESKELA, Haukipudas (FI); Jarmo Antero NIKULA, Jaali (FI); Aki Petri HAPPONEN, Kiiminki (FI); Mika Allan SALMELA, Oulu (FI); Susanna Katriina AHOLA, Oulu (FI)

(73) Assignee: NOKIA CORPORATION, Espoo (FI)

(21) Appl. No.: 13/174,335

(22) Filed: Jun. 30, 2011

(51) Int. Cl. G06F 3/02

(52) U.S. Cl. 345/169; 345/168

(57) ABSTRACT

A method, apparatus, and computer product for: receiving an indication of a size for a virtual keyboard; determining, based at least in part on the size, a layout for a virtual keyboard; and causing the display of a virtual keyboard according to the layout.

### TECHNICAL FIELD

The present application relates generally to the determination of virtual keyboard layouts.

### BACKGROUND

Developments in information technology have increased the availability of many different mediums for communication. However, they have also driven a demand for textual content.

Not only have developments such as the World Wide Web and electronic books made it possible for amateur authors to publish their own written material, but levels of textual communication have exploded with the introduction of e-mail, Short Message Service (SMS) messaging, instant messaging, internet forums, and social network websites. The creation and consumption of textual content remains prolific, and is an integral part of modern life.

Computing devices and other apparatus commonly provide functionality for text-based interactions. Such interactions may involve the creation or consumption of textual content, or may simply provide an interface to functionality offered via the apparatus.

A great deal of research effort has been devoted to devising and improving ways of allowing users to enter text into such apparatus. One approach is to provide a virtual keyboard.

A virtual keyboard is a user interface component that includes one or more virtual keys that are mapped to character insertions or other functions. For example, a virtual keyboard might include one or more virtual keys that are mapped ambiguously or ambiguously to alphanumeric characters and/or other symbols, which are inserted into a text input field in response to the user interacting in some predetermined way with the virtual key (e.g. by touching it on a touchscreen). Additionally, or alternatively, a virtual keyboard may include one or more virtual keys that are mapped to text input functions other than character insertions—functions such as backspace, shift, carriage return, and so on. Virtual keyboards additionally, or alternatively, may include one or more virtual keys that are mapped to functions unrelated to text input, for example a virtual key to close an application, or a virtual key to open a system menu. A “virtual keyboard” therefore contains one or more virtual keys, but the functions to which such virtual keys are mapped may vary according to the use case.

The “virtual” nature of a virtual key (and therefore virtual keyboard) refers to the fact that the key is not a physical key as might be found in e.g. the hardware qwerty keyboards that are sold as computer peripherals and typically connect to a personal computer using a USB or PS/2 interface, or the hardware ITU-T keyboards that are manufactured as an integral part of some mobile telephones. Instead, a virtual key is represented on a display, and the user interacts with the representation. For example, some virtual keyboards are implemented using touch screens, where a representation of one or more keys is drawn on the touch screen, and the user activates a virtual key by touching the touchscreen at a location overlapping the representation of the key.

### SUMMARY

A first example embodiment provides a method comprising: receiving an indication of a size for a virtual keyboard; determining, based at least in part on the size, a layout for a virtual keyboard; and

causing the display of a virtual keyboard according to the layout.

A second example embodiment provides apparatus comprising: a processor; and memory including computer program code, the memory and the computer program code configured to, working with the processor, cause the apparatus to perform at least the following: receive an indication of a size for a virtual keyboard; determine, based at least in part on the size, a layout for a virtual keyboard; and

cause the display of a virtual keyboard according to the layout.

A third example embodiment provides a computer program product comprising a computer-readable medium bearing computer program code embodied therein for use with a computer, the computer program code comprising: code for receiving an indication of a size for a virtual keyboard; code for determining, based at least in part on the size, a layout for a virtual keyboard; and code for causing the display of a virtual keyboard according to the layout.

Also disclosed is apparatus configured to perform any of the methods described or claimed herein.

Also disclosed is a computer program product comprising a computer-readable medium bearing computer program code embodied therein for use with a computer, the computer program code comprising: code for performing any of the methods described or claimed herein.

Also disclosed is apparatus comprising: means for receiving an indication of a size for a virtual keyboard; means for determining, based at least in part on the size, a layout for a virtual keyboard; and means for causing the display of a virtual keyboard according to the layout.

The means for receiving an indication of a size for a virtual keyboard may comprise means for receiving a user input that indicates the size. For example, the means may comprise or be embodied in the form of a touchscreen, keyboard, mouse, or other user input hardware, and/or a controller that is configured to receive and interpret signals from such hardware. Such controllers may include dedicated logic, for example an application specific integrated circuit, or a processor and computer program code for instructing the processor to receive and interpret the inputs. Alternatively, the indication may not comprise a user input, but instead a message, command signal, or other communication. The indication may be generated in the same apparatus or device in which it is received, in which case the means for receiving may comprise an interface to the local component generating the indication. In the case where the component generating the indication is the same component that receives the indication the means may be entirely internal to that component—for example, the means may be a processor that is programmed both to generate the indication and to receive it (e.g. as a result returned by a software function that is performed by the processor).

The means for determining, based at least in part on the size, a layout for a virtual keyboard may be similarly embodied in the form of dedicated logic (for example an application specific integrated circuit), or a processor and computer program code for instructing the processor to perform the identification. The means may include information relating to predefined layouts that are stored e.g. in a memory, such as information on how to access these layouts, or the layouts themselves.

The means for causing the display of a virtual keyboard according to the layout may comprise a display, such as a touchscreen, and/or a controller for controlling such a display. Alternatively, the means may comprise logic for controlling such a display or display controller, for example by issuing an instruction to the display and/or controller to cause the keyboard to be displayed. Such logic may comprise a processor.

In some example embodiments, all three of the above-described means may be comprised by a single processor.

### BRIEF DESCRIPTION OF THE DRAWINGS

For a more complete understanding of example embodiments of the present invention, reference is now made to the following descriptions taken in connection with the accompanying drawings in which:

FIG. 1 is an illustration of an apparatus according to an example embodiment;

FIG. 2 is an illustration of a device according to an example embodiment;

FIGS. 3A-G are illustrations of virtual keyboards according to example embodiments;

FIGS. 4A and 4B illustrate an example of a dynamically generated keyboard layout;

FIGS. 5A and 5B illustrate an example of a new virtual keyboard that replaces an old virtual keyboard of a different shape;

FIGS. 6A-D illustrate examples of virtual keyboards that have been fitted into areas of a display that do not exactly match the layout;

FIGS. 7A-C illustrate an example of an old virtual keyboard being replaced by a new virtual keyboard of larger size;

FIGS. 8A-I illustrate examples virtual keyboards and computing devices in which the indication of a size is made according to different example approaches; and

FIG. 9 is a flow chart illustrating a method according to an example embodiment.

### DETAILED DESCRIPTION OF THE DRAWINGS

Example embodiments of the present invention and their potential advantages are understood by referring to the drawings.

A computing device that controls the display of a virtual keyboard and the user interactions with it may be configured in such a way that more than one virtual keyboard can be implemented by the device. For example, a device may permit a user to select between two or more keyboards of differing sizes and/or layouts. Selection between the available virtual keyboards may also be performed automatically by the device, for example based on the orientation of a display between portrait and landscape positions. The ability to switch between keyboard implementations has the potential to improve user experience by allowing desirable choice of keyboards to me made available to a user.

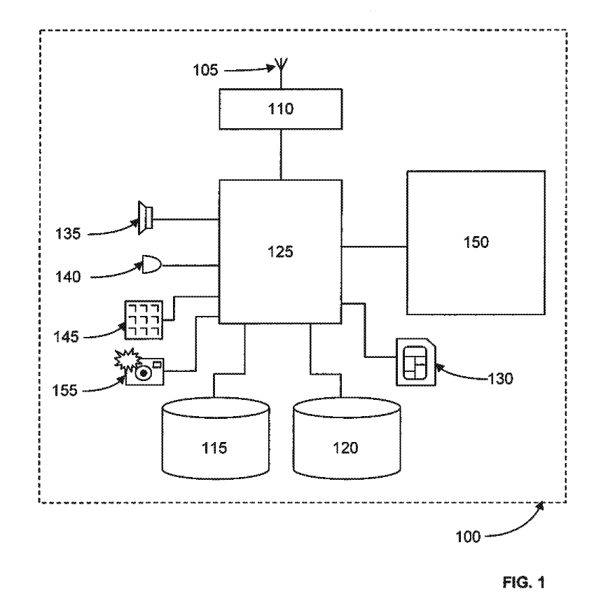

FIG. 1 illustrates an apparatus 100 according to an example embodiment. The apparatus 100 may comprise at least one antenna 105 that may be communicatively coupled to a transmitter and/or receiver component 110. The apparatus 100 may also comprise a volatile memory 115, such as volatile Random Access Memory (RAM) that may include a cache area for the temporary storage of data. The apparatus 100 may also comprise other memory, for example, non-volatile memory 120, which may be embedded and/or be removable. The non-volatile memory 120 may comprise an EEPROM, flash memory, or the like. The memories may store any of a number of pieces of information, and data—for example an operating system for controlling the device, application programs that can be run on the operating system, and user and/or system data. The apparatus may comprise a processor 125 that can use the stored information and data to implement one or more functions of the apparatus 100, such as the functions described hereinafter. In some example embodiments, the processor 125 and at least one of volatile 115 or non-volatile 120 memories may be present in the form of an Application Specific Integrated Circuit (ASIC), a Field Programmable Gate Array (FPGA), or any other application-specific component. Although the term “processor” is used in the singular, it may refer either to a singular processor (e.g. an FPGA or a single CPU), or an arrangement of more than one singular processor that cooperate to provide an overall processing function (e.g. two or more FPGAs or CPUs that operate in a parallel processing arrangement).

The apparatus 100 may comprise one or more User Identity Modules (UIMs) 130. Each UIM 130 may comprise a memory device having a built-in processor. Each UIM 130 may comprise, for example, a subscriber identity module, a universal integrated circuit card, a universal subscriber identity module, a removable user identity module, and/or the like. Each UIM 130 may store information elements related to a subscriber, an operator, a user account, and/or the like. For example, a UIM 130 may store subscriber information, message information, contact information, security information, program information, and/or the like.

The apparatus 100 may comprise one or more user interface devices, for example, a microphone 135 and an audio output device such as a speaker 140. The apparatus 100 may comprise one or more hardware controls, for example a plurality of keys laid out in a keypad 145. Such a keypad 145 may comprise numeric (for example, 0-9) keys, symbol keys (for example, #, *), alphabetic keys, and/or the like for operating the apparatus 100. For example, the keypad 145 may comprise a QWERTY (or local equivalent) keypad arrangement. The keypad may instead comprise a different layout, such as E.161 standard mapping recommended by the Telecommunication Standardization Sector (ITU-T). The keypad 145 may also comprise one or more soft keys with associated functions that may change depending on the input of the device. In addition, or alternatively, the apparatus 100 may comprise an interface device such as a joystick, trackball, or other user input component.

The apparatus 100 may comprise one or more display devices such as a screen 150. The screen 150 may be a touchscreen, in which case it may be configured to receive input from a single point of contact, multiple points of contact, and/or the like. In such an example embodiment, the touchscreen may determine input based on position, motion, speed, contact area, and/or the like. Suitable touchscreens may involve those that employ resistive, capacitive, infrared, strain gauge, surface wave, optical imaging, dispersive signal technology, acoustic pulse recognition or other techniques, and to then provide signals indicative of the location and other parameters associated with the touch. A “touch” input may comprise any input that is detected by a touchscreen including touch events that involve actual physical contact and touch events that do not involve physical contact but that are otherwise detected by the touchscreen, such as a result of the proximity of the selection object to the touchscreen. The touchscreen may be controlled by the processor 125 to implement an on-screen keyboard.

In other examples, displays of other types may be used. For example, a projector may be used to project a display onto a surface such as a wall. In some further examples, the user may interact with the projected display, for example by touching projected user interface elements. Various technologies exist for implementing such an arrangement, for example by analysing video of the user interacting with the display in order to identify touches and related user inputs.

The apparatus 100 either comprises means for implementing a virtual keyboard, or can be used in conjunction with such means. For example, in the apparatus 100 of FIG. 1, representations of one or more virtual keys making up a virtual keyboard may be drawn on the screen 150 under control of the processor 125. If the screen 150 is a touch screen, user activations of the virtual keys may be determined by the processor 125, based on indications received from the touch screen that the processor 125 interprets as touch gestures made in relation to the representations of the virtual keys. Other techniques for providing a virtual keyboard may be selected based on the use case, for example a virtual keyboard may be provided by drawing representations of virtual keys on the screen 125 and determining activation of the keys based on inputs received from other interfaced devices, such as hardware buttons, a mouse, and a joystick.

For simplicity, the present invention will be described in relation to a touch screen interface, but it must be understood that the invention is not necessarily limited to touch screen embodiments, and may be embodied in relation to other types of virtual keyboard interface—both those types described herein, and other types that will be known or obvious to the skilled person. Furthermore, the presence of a hardware keyboard 145 does not preclude the use of a virtual keyboard in addition or instead of the hardware keyboard. For example, the virtual keyboard may include keys having functions that are not accessible (or are not easily accessible) using the hardware keyboard, or may repeat hardware keys in a more appropriate size, layout, and/or representation (e.g. using colour coding, or dynamically updated labels for the keys).

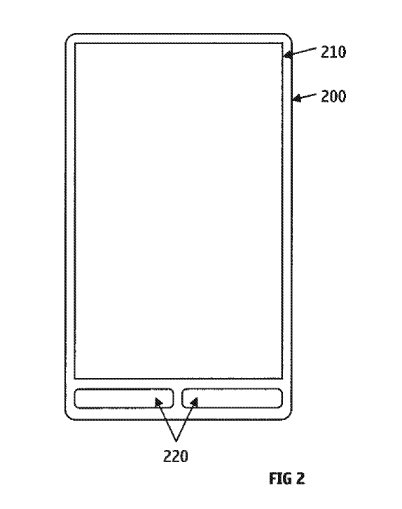

FIG. 2 illustrates a computing device 200 according to an example embodiment. FIG. 2 may comprise the apparatus 100 of FIG. 1. The device has a touch screen 210 and hardware buttons 220, although different hardware features may be present. For example, instead of a touchscreen 210 the device 200 may have a non-touch display upon which a cursor can be presented, the cursor being movable by the user according to inputs received from the hardware buttons 220, a trackball, a mouse, or any other suitable user interface component.

Non-exhaustive examples of other devices including apparatus, implementing methods, or running or storing computer program code according to example embodiments of the invention may include a mobile telephone or other mobile communication device, a personal digital assistant, a laptop computer, a tablet computer, a games console, a personal media player, an internet terminal, a jukebox, or any other computing device. Suitable apparatus may have all, some, or none of the features described above.

Example embodiments of the invention will be described with reference to the features presented in the context of apparatus 100 and device 200 shown in FIGS. 1 and 2. However, it will be understood that the invention is not necessarily limited by the inclusion of all of the elements described in relation to the drawings or shown in them, and that the scope of protection is instead defined by the claims.

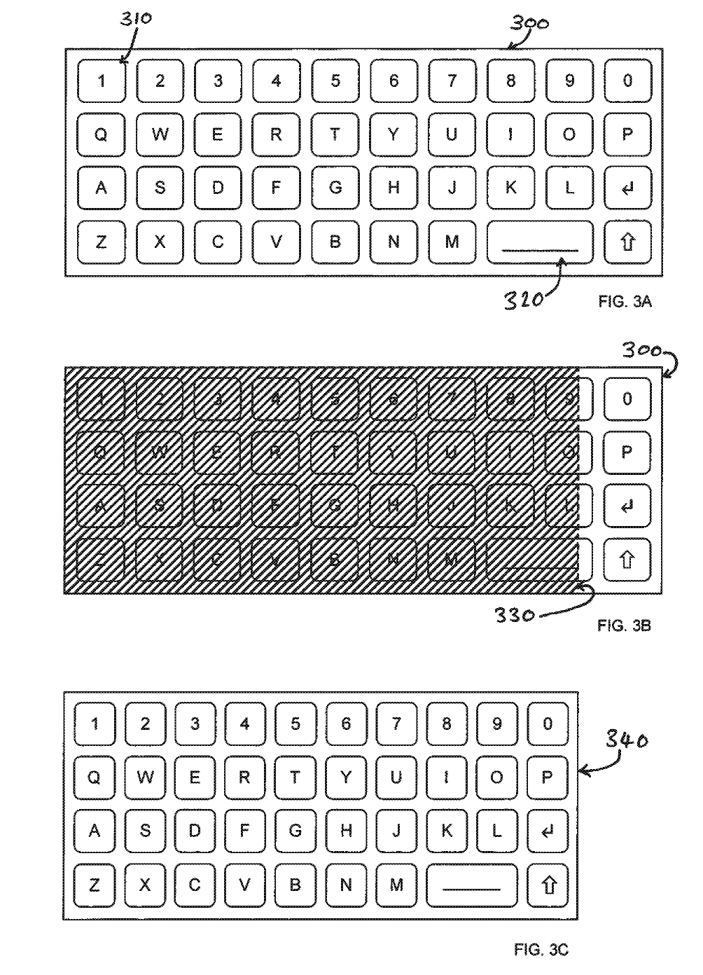

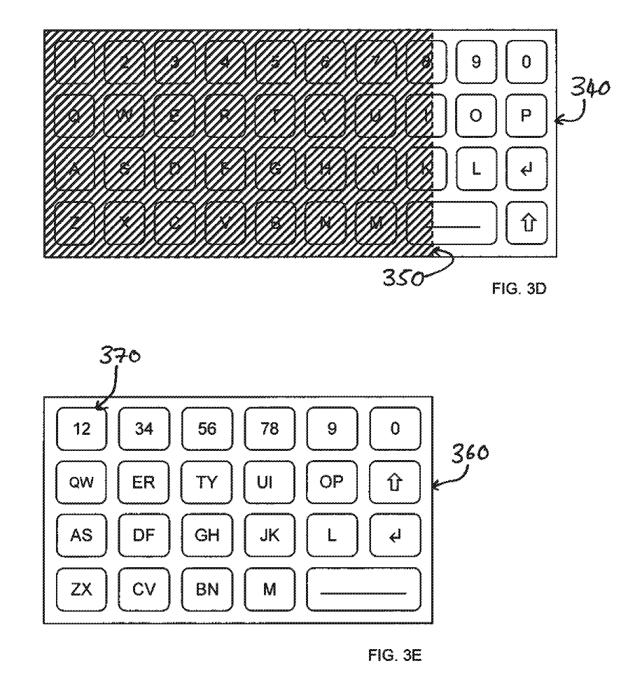

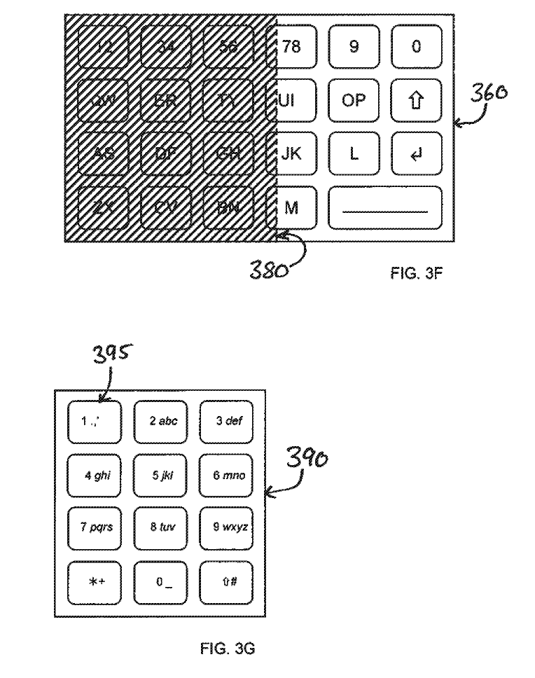

FIG. 3A shows an example of a virtual keyboard 300. This particular keyboard is an alphanumeric QWERTY keyboard, and comprises 39 keys laid-out according a 10×4 (10 columns, 4 rows) grid. Keys are labelled with, and mapped to, particular functions. For example, key 310 is labelled with the character “1” and is mapped to the insertion of the character “1”. Note that the spacebar 320 is enlarged to make it easier for the user to find and activate, and it covers two squares in the 10×4 grid. This is just one example of a virtual keyboard layout—an almost limitless number of alternative layouts are possible and not all of these will correspond to rectangular or other shaped grids.

FIG. 3B illustrates the virtual keyboard 300 of FIG. 3A and a shaded area 330. This shaded area 300 may or may not be displayed to the user, and it is used in the drawings merely to illustrate a new size of virtual keyboard that has been in some way indicated. The indication may be based upon a user input that defines the area 300 or defines a transformation of the keyboard 300 (e.g. an enlargement, a translation, or a combination of these and/or other transformations). The indication may instead be generated independently of the user. For example, the indication may be generated by an application that requires a particular display area in which to present content to the user. By way of example, the indication may be generated by hardware and/or software that has determined a physical characteristic of the device's environment (e.g. a change in position, orientation, or type of motion), has determined a change in the user of the device (e.g. via authentication information provided by the new user, or by biometric sensing), or based on any other suitable criteria. The generation of the indication other than via a user input specifying the size is referred to as an “automatic” generation—that is, a generation that is autonomously performed by e.g. a computing device rather than immediately based upon a user input that defines the size.

Note that the area 330 represents a size of keyboard that is smaller than the keyboard 300 of FIG. 3A. Keyboard 300 may therefore replaced by a new keyboard 340 that is selected based on the size of the area 330—this new keyboard 340 is shown in FIG. 3C.

Note that although the new keyboard 340 of FIG. 3C is smaller than the original keyboard of FIG. 3A, the layout of the keys of the two keyboards is the same. The new keyboard 340 is simply the old keyboard 300 re-scaled in the horizontal axis.

At this point, the term “layout” will be defined in the context of a virtual keyboard. The “layout” of a keyboard defines the positioning of the keys relative to one another. If two keyboards differ only in terms of their scale then in at least some examples they can be said to represent the same “layout”—even if they differ according to different scales in different axes. Thus, if two keyboards can be made congruent by stretching them in one or more axes then they have the same “layout”. However, if the two keyboards cannot be made congruent by stretching then they necessarily have different layouts.

Keyboards that are made up of different sets of keys will necessarily always have different layouts. However, keyboards that are made up of the same set of keys may or may not have different layouts depending upon the locations of the keys within the keyboards.

Thus, two keyboards that have different sizes may or may not have different “layouts”.

Returning to the keyboards 300, 340 of FIGS. 3A and 3C, these keyboards differ only in their scale in the horizontal axis and therefore have the same layout.

Keyboard 340 has been selected to replace keyboard 300 based on one or more heuristics. This selection may be performed by a processor, for example, executing suitable computer program instructions. There are many different heuristics that may be used, and the most suitable heuristics will vary according to use case. Examples of different possible heuristics will be discussed later, but in the current example it has been determined using such heuristics that a re-scaled version of the original keyboard 300 is the most suitable choice for the new size represented by area 300.

FIG. 3D shows keyboard 340 from FIG. 3C, and a still smaller shaded area 350 representing a still smaller size of keyboard.

Again, heuristics (described later) may be applied to the new size represented by area 350, and a suitable keyboard is selected for the new size based on these heuristics.

FIG. 3E shows the keyboard 350 that has been selected, in this example, for the new size represented by area 350. The keyboard 350 of FIG. 3E has a different layout to the previous keyboards 300, 350 of FIGS. 3A and 3C in addition to being a different size. In particular, and unlike the previous keyboards 300, 340, the keyboard 340 of FIG. 3E includes virtual keys such as key 370 that are mapped to more than one possible function. This keyboard type will be referred to as a “dual-character QWERTY” since it follows the general pattern of a QWERTY keyboard, but has up to two characters mapped to each key.

Key 370 is mapped to the insertion of character “1” and also to the insertion of character “2”. There are various ways in which an activation of this key 370 can be associated with one or other of these functions, and the particular technique used will be determined by the nature of the keyboard 360. For example, if keyboard 360 is an unambiguous keyboard then different types of actuation of the key (e.g. single or double taps, short and long taps, swipes in different directions) may be mapped to the insertion of each of characters “1” and “2”. If the keyboard 360 is ambiguous then the same actuation (e.g. a tap) may be mapped to the insertion of either character “1” or character “2” with the appropriate character selected based upon the results of a predictive text algorithm or other suitable method of disambiguation.

FIG. 3F shows keyboard 360 from FIG. 3E, and a yet still smaller shaded area 380 representing a yet still smaller size of keyboard.

Once again, heuristics (described later) may be applied to the new size represented by area 380, and a suitable keyboard is selected for the new size based on these heuristics.

FIG. 3G shows the keyboard 380 that has been selected, in this example, for the new size represented by area 380. Keyboard 380 happens to be an ITU-T keyboard (a keyboard that conforms to the International Telecommunication Union's Telecommunication Sector recommendation E.161). The keyboard 380 of FIG. 3G has a different layout to any of the previous keyboards 300, 350, 360 of FIGS. 3A, 3C, and 3E in addition to being a different size. Similar to keyboard 360 of FIG. 3E, keyboard 390 of FIG. 3G includes virtual keys such as key 395 that are mapped to more than one possible function. Again, the ambiguous or unambiguous nature of this mapping depends on the particular nature of keyboard 380, and the mapping of key 395 to any of the characters “1”, “.”, “,”, and “'” is governed by this.

As previously mentioned, the choice of keyboard for each new size is dependent upon one or more heuristics. Heuristics may be chosen to match an appropriate keyboard to the indicated size. The choice of heuristic(s) may vary, but some examples of potentially suitable heuristics will be described once the nature of the term “size” has been properly explained.

As used herein, “size” may refer to one or more of a number of different attributes. For example, a “size” may define an area, being either an absolute area (e.g. 10 cm²) or a relative area (e.g. 20%) of e.g. a total or partial area of a display. Alternatively, a “size” may be an extension in one of more axes (e.g. a 5 cm horizontal extension and a 2 cm vertical extension), and again this extension may again be absolute or relative to e.g. a total or partial area of a display. Alternatively, a “size” may be a description of a particular shape (e.g. a rectangle) described in absolute or relative terms (e.g. having horizontal and vertical sides of 4 cm and 3 cm respectively, or having a horizontal:vertical aspect ratio of 4:3). Alternatively, the “size” may be a combination of one or more of these or any other suitable attributes.

The heuristics used to map keyboards to sizes may include the mapping of particular keyboard layouts to particular ranges of sizes. For example, in the examples shown in FIGS. 3A-G, large sizes may be mapped to the layout of QWERTY keyboard 300, medium sizes mapped to the layout of dual-character QWERTY keyboard 360, and small sizes mapped to the layout of ITU-T keyboard 380. This mapping may be achieved by pre-defining threshold size values and inequalities that will map given sizes to given layouts based on these threshold size values. Clearly, the choice of layouts, threshold values, and inequalities will be dependent upon the use case and it is not intended that the specific choices illustrated example of FIGS. 3A-3G should be limiting.

Within a given range, the mapped keyboard layout may or may not be scaled based on the size, depending on the choice of heuristic. In the example of FIGS. 3A-G the QWERTY keyboard layout used for keyboard 300 of FIG. 3A was reduced in scale to provide keyboard 340 of FIG. 3C in response to the indication of a size that was smaller than that of keyboard 300 but not sufficiently small to warrant a new layout (e.g. the dual-character QWERTY layout). However, if an alternative heuristic that did not allow for resizing was selected, then keyboard 300 would not have been re-scaled and would instead have been retained in its original size after the size represented by area 330 was indicated.

In one example, a set of keyboard layouts are assigned to predetermined ranges of keyboard size.

According to an alternative heuristic, the choice of layout is dependent upon the size of the virtual keys that will appear in a virtual keyboard and the number of keys that occur in that layout. For example, when a new size was indicated in FIG. 3B for the keyboard 300 of FIG. 3A, a calculation may have been performed to determine the average, maximum, and/or minimum dimensions of the keys within each available layout, scaled so as to best fit the indicated size. The heuristic may then be used to select the keyboard that has the maximum number of keys but no keys smaller than a particular minimum threshold key size. Such a heuristic may be used to provide the maximum number of virtual keys whilst simultaneously ensuring that the keys remain large enough to be easily selected by the user. Small keys are difficult to target and select on e.g. touch screen and avoiding keys below a certain minimum dimension can help prevent the situation where a user aims for one key and inadvertently activates its neighbour instead of (or in addition to) the key he was aiming for.

Rather than selecting from predefined layouts, the heuristics may perform a selection from dynamically-generated layouts, or from a combination of predefined layouts and dynamically generated layouts.

The keyboards described so far are all examples of predefined keyboards—the keys follow a pattern that has been specified at some prior point in time when the keyboard was designed (e.g. by a computer programmer). However, it is also possible to dynamically create a new keyboard layout when the need arises for it, for example by enabling the wrapping of keys between rows of an existing keyboard in order to allow the aspect ratio of that keyboard to be changed, or by automatically populating a given keyboard area and/or shape with keys according to suitable rules for governing their layout.

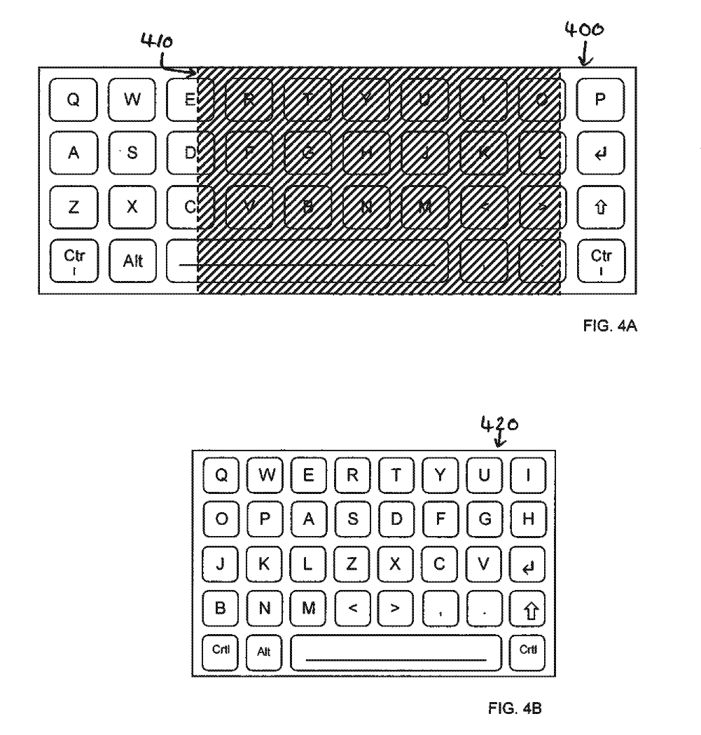

FIGS. 4A and 4B illustrate an example of a dynamically generated keyboard layout, selected according to a suitable heuristic.

FIG. 4A shows a QWERTY keyboard 400 (without numerical keys, this time) and a shaded area 410 that represents a new size. The QWERTY keyboard has 35 keys arranged according to a 10×4 grid (the spacebar takes up 5 grid spaces).

FIG. 4B shows a new keyboard 420, selected based upon the size represented by area 410. This new keyboard 420 contains the same 35 keys present in the original keyboard 400, but the keys are arranged according to a different layout. Specifically, the keys of the original keyboard 400 have been dynamically rearranged in an 8×5 grid (with the spacebar again taking up 5 grid spaces) so as to best fit the new size, resulting in a new keyboard 420 according to a different layout.

Various different rules can be employed to implement the dynamic generation of new keyboard layouts. In the example of FIGS. 4A and 4B the rules employed to create the new keyboard layout were as follows:

1. The left “Ctrl”, “Alt”, spacebar, and right “Ctrl” keys must be located in the bottom row, and in arranged that order from left to right;

2. The “Shift” key must be located in the rightmost column of the second to bottom row;

3. The “Enter” key must be located in the rightmost column of the third to bottom row; and

4. Every other key must appear in its original order, wrapped left-to-right and then top-to-bottom across a number rows and columns chosen to best fill an available area of the screen that is dictated by the new size.

Other sets of rules may be used to dynamically generate other keyboard layouts for selection by the heuristics.

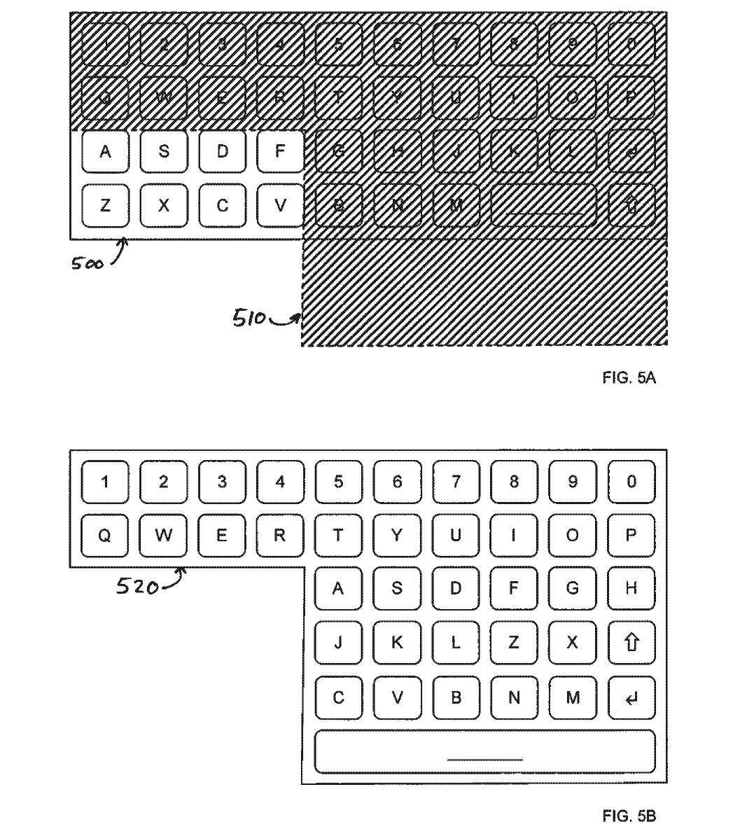

The example illustrated in FIGS. 4A and 4B showed the dynamic generation of a layout based on a size that involved a change in the aspect ratio of a rectangle. However, keyboard shapes are not necessarily limited to rectangles, and neither therefore are sizes. FIGS. 5A and 5B illustrate an example where the new size represents a very different shape to that of the original keyboard.

In FIG. 5A a rectangular QWERTY keyboard 500 is illustrated that is similar to that 300 of FIG. 3A. Also shown is a shaded area 510 that corresponds to a new size, but in this case the area is not rectangular (like keyboard 500), but is instead L-shaped. This new shape may have been defined in many different ways, and examples of these will be discussed later. One possible way for the shape to be defined is for the user to make an input that defines the perimeter of the area 510, for example by tracing the perimeter with a swipe on a touch screen. The shape may instead have been defined in other ways, for example automatically defined to fill an empty area of the display and avoid overlaying certain areas of a display such as currently displayed content or content that is to be displayed simultaneously with the keyboard. Any other shape may have been used in place of the L-shape, which is an arbitrary choice for the purposes of illustration only.

In response to the indication of the size associated with shape 510, a new keyboard 520 may be selected, and this new keyboard 520 is shown in FIG. 5B. Although the keyboard may correspond to a predefined layout, in this particular example it has been dynamically generated based on the new size. In the case of sizes that relate to arbitrary shapes, the dynamic generation of layouts can in some examples help improve the choice of a suitable layout without the need to have predefined a large number of layouts of different shapes.

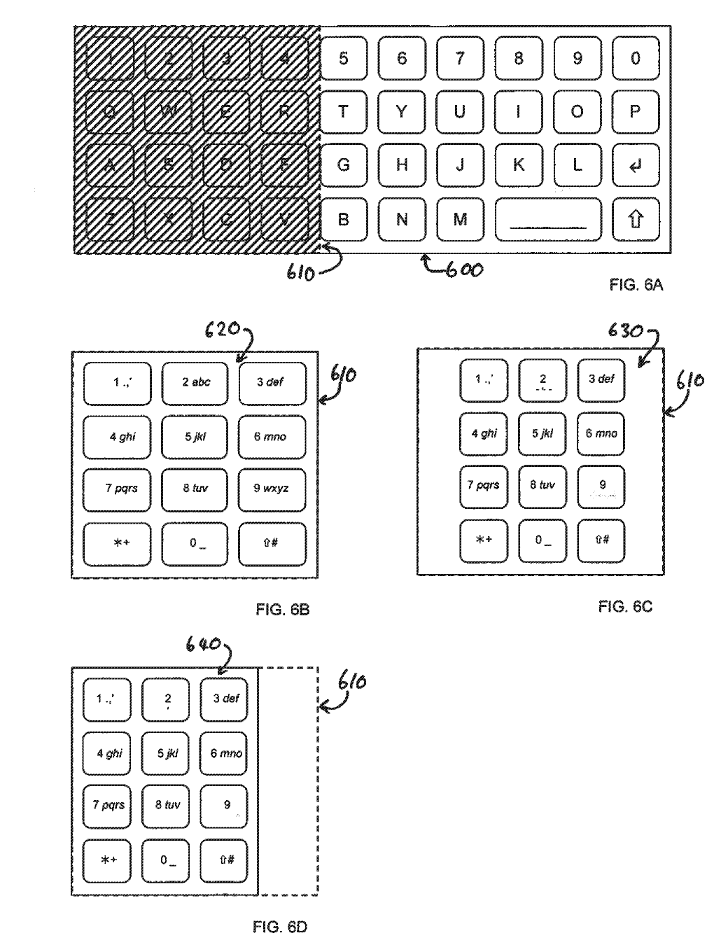

FIGS. 6A-D illustrate examples of approaches that may be used to fit a particular layout (predetermined, or dynamically generated) to a size that defines a display area into which the layout is not an exact fit.

FIG. 6A shows a QWERTY keyboard 600 and a shaded area 610 that represents a new size. The particular heuristic used in this example selects a predefined ITU-T layout for the new keyboard, but the dimensions of the ITU-T layout do not quite match the aspect ratio of the size represented by area 610. FIGS. 6B-D show three approaches to resolving this discrepancy. In each of FIGS. 6B-D, area 610 is represented by a dashed line (which coincides with entirety of the border of the keyboards 630, 640 in FIGS. 6B and 6C).

In FIG. 6B a keyboard 630 is selected in which the predefined ITU-T layout has been transformed to fit the new size 610. The particular transform used in this example is a horizontal stretch, but other transformations may be selected as appropriate. In some implementations the entire keyboard 630 is stretched, whereas in others only the keys are stretched and the separations between them remain constant. Stretching the keyboard 630 helps to maximise the area of the keys in order to assist the user in accurately interacting with them.

FIG. 6C shows an alternative approach in which the border of the keyboard 640 has been transformed in order to fit the new size 610, but the keys themselves are maintained according to their layout (other than possibly being uniformly scaled according to the new size). In the illustrated example of FIG. 6C the keys are centred in the keyboard 640, but other alignments are also possible, such as an alignment against one edge of the keyboard 640. Although this approach does not maximise the key area, it does prevent distortion of the keys.

FIG. 6D shows an alternative approach in which neither the border nor the keys of the keyboard 650 have been transformed (other than possibly by uniform scaling according to the new size). In this particular illustration, the keyboard has been aligned to the left of the area 610 corresponding to the new size, but other alignments are equally possible, such as centring.

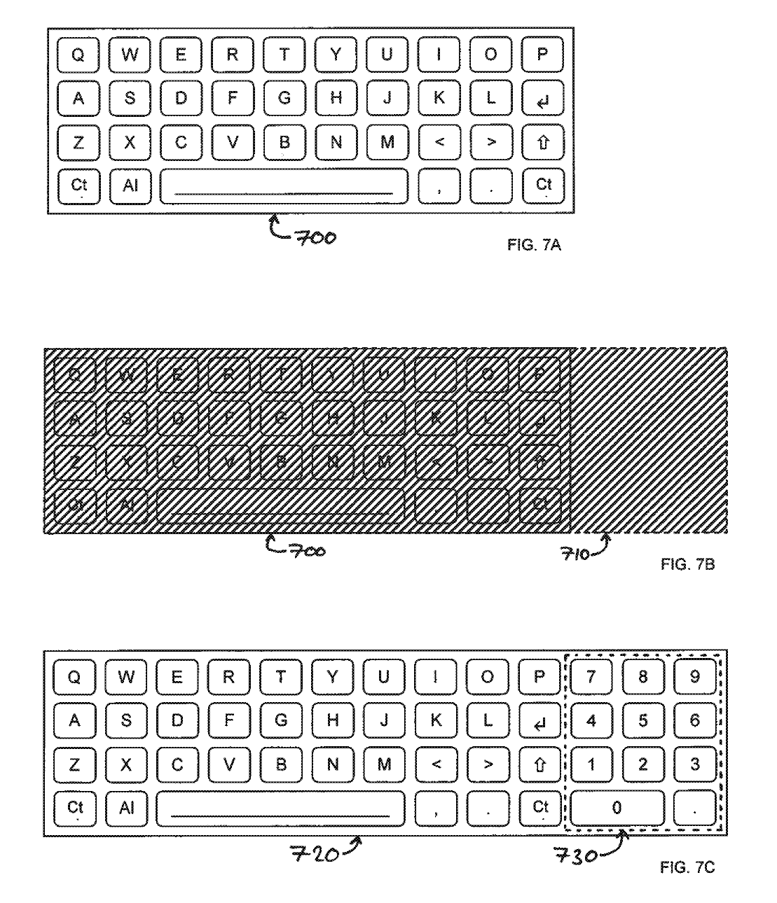

Although the functionality described so far is equally applicable to both increases and decreases in size, the specific examples have demonstrated only reducing keyboard sizes. FIGS. 7A-C illustrate an example where the size is instead increased.

FIG. 7A illustrates a QWERTY keyboard 700 that is similar to the keyboard 400 of FIG. 4A.

FIG. 7B shows a shaded area 710 that represents a new size that has been indicated for the keyboard. Using the same principles as described previously, heuristics are used to determine a new keyboard based on the now larger size.

FIG. 7C shows the new keyboard 720 dictated by the heuristics. In this particular example, the heuristics have dictated the use of a new layout—a QWERTY layout that includes a numeric pad 730 to the right of the other keys.

The heuristics may impose limits on the maximum and/or minimum sizes. For example, any size below a minimum threshold may result in the selection of a particular keyboard being the smallest possible keyboard permitted. Similarly, any size above a maximum threshold may result in the selection of a particular keyboard being the largest keyboard permitted. This prevents, for example, the selection of keyboards that are too small for the user to accurately interact with, or too large to display within an available area of a display.

Another approach to handling indications of sizes that lie outside a permitted range may result in no change being made to the keyboard. In such cases, an indication of an error may be provided either to the user, or to a component of an apparatus—for example a processor that provided the indication of the non-permitted size.

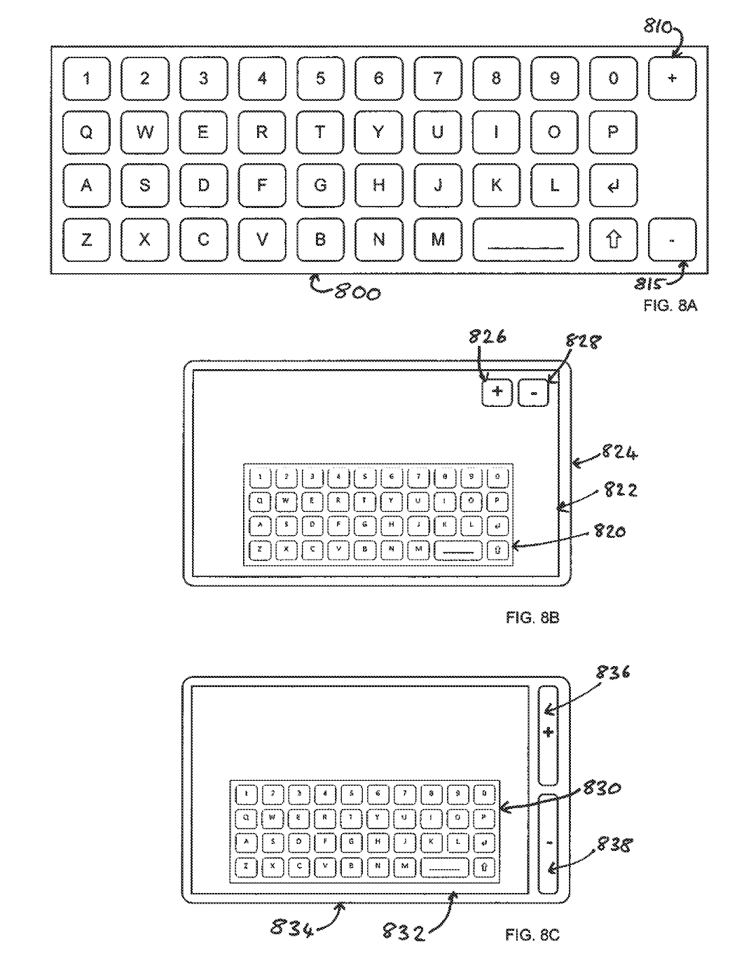

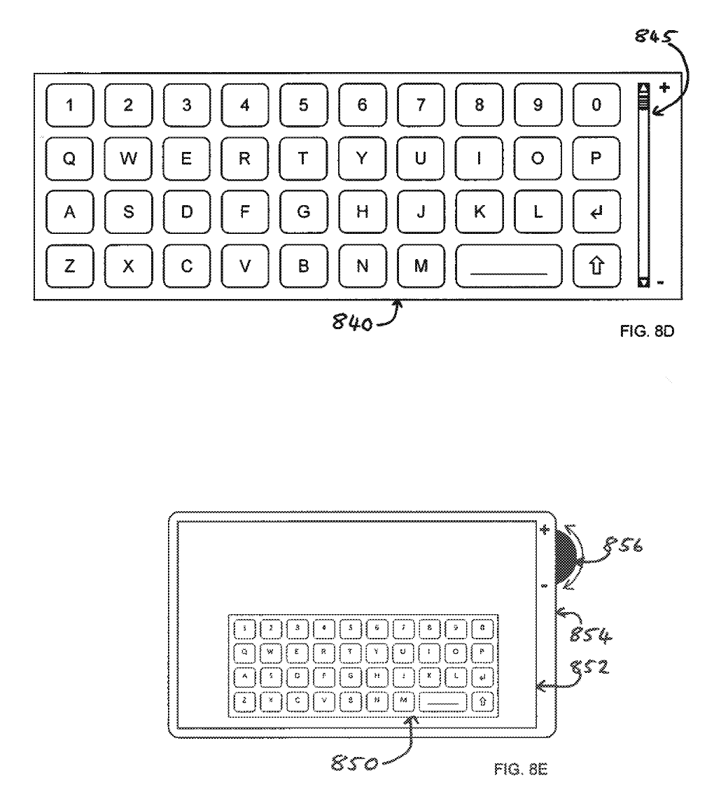

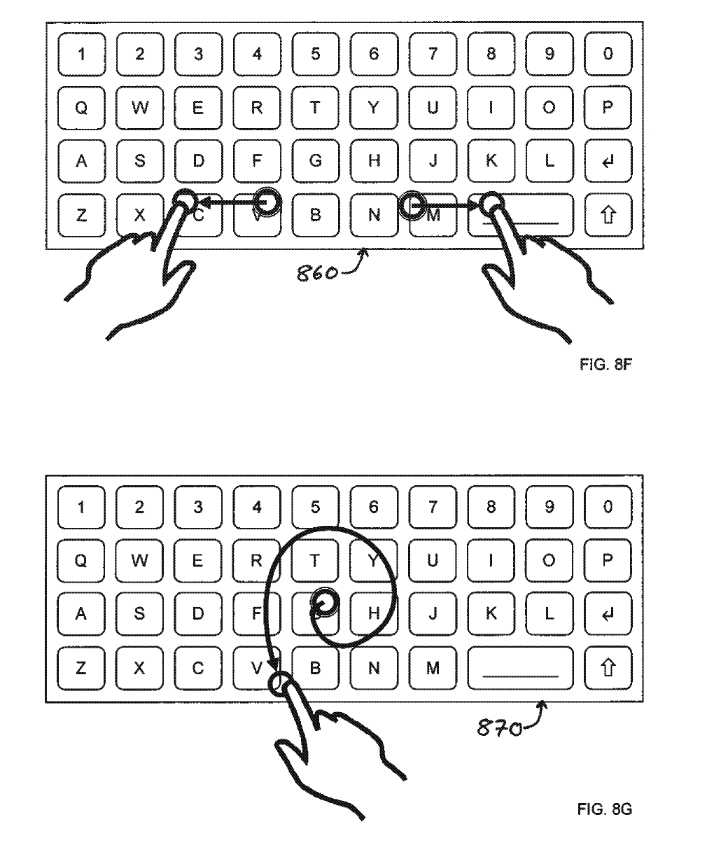

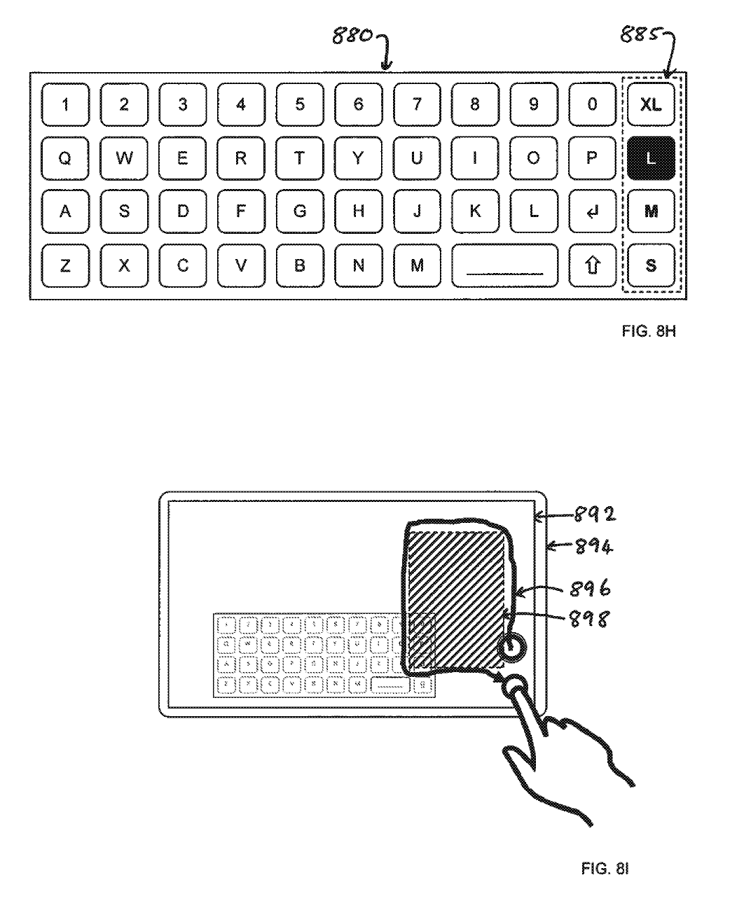

The indication of a size can be made in many different possible ways, with the most appropriate chosen according to the use case. Some suitable approaches are illustrated in FIGS. 8A-I.

In some embodiments the user is provided with a control that allows him either to progress through a set of discrete predefined sizes, or to similarly progress along an analogue scale of sizes. In either case, UI controls may be provided to increase and/or decrease the current size.

FIG. 8A illustrates a virtual keyboard 800 that includes virtual keys 810, 815 relating to such UI controls for increasing and decreasing (respectively) the current size.

FIG. 8B illustrates an alternative embodiment wherein a virtual keyboard 820 is displayed on a display 822 of a device 824, and virtual keys 826, 828 are also displayed for increasing and decreasing the size (respectively) but do not form part of the keyboard itself. The virtual keys 826, 828 are not necessarily displayed on the same display 822 in all such examples.

FIG. 8C illustrates an alternative example wherein a virtual keyboard 830 is displayed on a display 832 of a device 834, and physical (i.e. hardware) keys 836, 838 are provided on the device 834 for increasing and decreasing the size. Although the physical keys 836 and 838 are illustrated as part of the same device 834 as the display 832, they may be located on a separate device, with information regarding their actuation (or the size they control) communicated to device 834.

Keys are not the only UT component that can be used to increase and decrease the size.

FIG. 8D illustrates a virtual keyboard 840 that includes a slider component 845 that can be moved up and down to increase or decrease (respectively) the size. Other orientations of slider, locations of the slider 845 (e.g. other than as part of the keyboard) and types of UI component may be used instead.

FIG. 8E illustrates an example where the size is controlled by an alternative physical (i.e. hardware) UI component. In the example of FIG. 8E a virtual keyboard 850 is displayed on a display 852 of a device 854, and a rotatable wheel 856 is provided for increasing and decreasing the size according to rotations in each of two directions. Although the rotatable wheel 856 is illustrated as part of the same device 854 as the display 852, it may be located on a separate device, with information regarding its actuation (or the size it defines) communicated to device 854.

In some other examples, increases and decreases in the size are mapped to touch gestures performed on or otherwise in relation to the virtual keyboard.

FIG. 8F illustrates an example where a user is performing a pinch-zoom gesture upon a virtual keyboard 860. In response to the pinch-zoom gesture, the size may be increased by a fixed amount, or an amount that is proportional to a characteristic of the pinch-zoom gesture—for example its speed, length, or pressure. A reversed pinch-zoom gesture may be similarly employed to decrease the size.

FIG. 8G illustrates an example where a user is performing a spiral-zoom gesture upon a virtual keyboard 870. The gesture illustrated is an anticlockwise spiral-zoom, but clockwise spiral-zoom gestures may be used instead of or in addition to anticlockwise in different examples. In response to the spiral-zoom gesture, the size may be increased by a fixed amount, or an amount that is proportional to a characteristic of the spiral-zoom gesture—for example its speed, length, or pressure. A reversed spiral-zoom gesture (in which the loops converge rather than diverge) may be similarly employed to decrease the size.

Instead of (or in addition to) providing a means for the user to progressively increase or decrease the current size, some examples allow the user to select a particular size without the need for such progression. Such an example is illustrated in FIG. 8H.

FIG. 8H illustrates a virtual keyboard 880 that includes four special virtual keys 885 that can each be actuated by the user to select a particular size. In the illustrated example, these keys are labelled Extra Large (“XL”), Large (“L”), Medium (“M”), and Small (“S”), and the Large key is highlighted as currently selected. User activation of one of the special virtual keys 885 provides an indication of a predetermined size associated with that key 885, regardless of the size of the virtual keyboard 880 displayed at the time. Different arrangements of virtual keys or other components could be provided in other examples whilst still permitting the user to select a particular desired size in this discrete manner.

When the user wishes to define a size that incorporates a particular shape, other functionality may need to be provided. In some examples, the user is provided with UI controls that allow him to select between or modify predefined shapes. In other examples, the user is provided with a way to draw or otherwise define a custom shape. An example of this latter case is illustrated in FIG. 8I.

FIG. 8I illustrates an example where a user has swiped a path 896 on a touch screen 892 of a device 894 in order to define a size (including a shape). In alternative examples, the path may be drawn or defined in other ways, for example by using a mouse or a light pen.

There are a number of different ways in which the path 896 can be used to define the size in examples such as that of FIG. 8I. In the illustrated example a shaded area 898 representing the size has been illustrated. This shaded area 898 (and therefore also the size) has been determined by finding the largest rectangular area that fits entirely within the path 896 that the user has drawn. In other examples other approaches may be used to fit the size to the path 896, including determining the smallest rectangular area to fully enclose the path 896, or the rectangle closet matching the path 896 (e.g. by finding the midline for each detected edge of the path 896). In some examples predefined shapes other than a rectangle may be fitted to the path 896, and the shape used may or may not be required to have a particular orientation relative to the display 898 (e.g. at least one side parallel to an edge of the display). In some other examples, the shape corresponds exactly to the shape of the path 896.

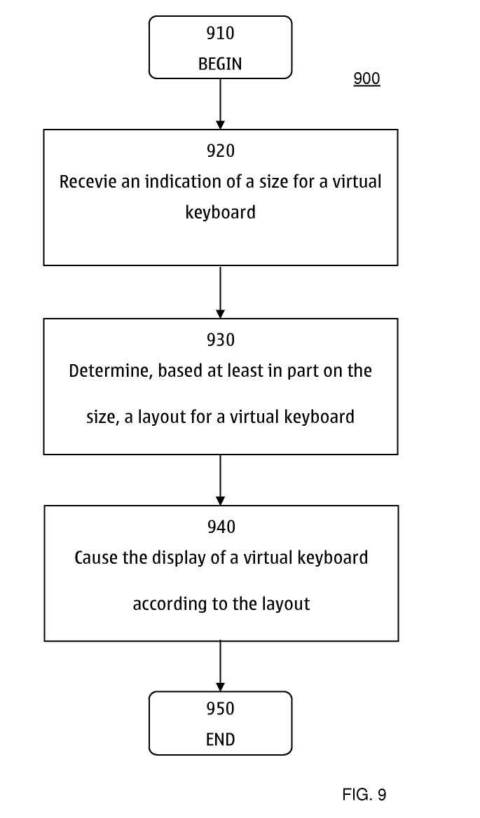

FIG. 9 is a flow chart that illustrates a 900 according to an example embodiment. The method begins at 910. At 920, an indication of a size for a virtual keyboard is received. This indication may be, for example, a user input that specifies a particular size—although other examples are discussed above. At 930 a layout for a virtual keyboard is determined, based at least in part on the size. Approaches to performing this determination have already been discussed, but one example is the case where the indicated size is compared to one or more ranges and one of a plurality of predetermined layouts is selected based upon that comparison. At 940 the display of a virtual keyboard according to the layout is caused. This displaying might be achieved, in some examples, by controlling or otherwise instructing a display to display the keyboard.

Finally, the method ends at 950. This method may be adapted, in various further examples, to include any of the functionality described previously.

Without in any way limiting the scope, interpretation, or application of the claims appearing below, a technical effect of one or more of the example embodiments disclosed herein is that when a keyboard is resized the most appropriate layout for the new size may be selected and used to display the keyboard. This can help to avoid the situation where the resized keyboard has keys that are too small for the user to accurately select, and provide a way to ensure that the shape of the keyboard is appropriate for the available area of the display. It may also assist in increasing the number of keys to improve the user experience when the size of the keyboard is increased and there is sufficient space available in the keyboard that the additional keys will not be too small for the user to accurately select.

Example embodiments of the present invention may be implemented in software, hardware, application logic or a combination of software, hardware and application logic. The software, application logic and/or hardware may reside on a removable memory, within internal memory or on a communication server. In an example embodiment, the application logic, software or an instruction set is maintained on any one of various conventional computer-readable media. In the context of this document, a “computer-readable medium” may be any media or means that can contain, store, communicate, propagate or transport the instructions for use by or in connection with an instruction execution system, apparatus, or device, such as a computer, with examples of a computer described and depicted in FIG. 1. A computer-readable medium may comprise a computer-readable storage medium that may be any media or means that can contain or store the instructions for use by or in connection with an instruction execution system, apparatus, or device, such as a computer.

In some example embodiments, the invention may be implemented as an apparatus or device, for example a mobile communication device (e.g. a mobile telephone), a PDA, a computer or other computing device, or a video game console.

If desired, the different functions discussed herein may be performed in a different order and/or concurrently with each other. Furthermore, if desired, one or more of the above-described functions may be optional or may be combined.

Although various aspects of the invention are set out in the independent claims, other aspects of the invention comprise other combinations of features from the described example embodiments and/or the dependent claims with the features of the independent claims, and not solely the combinations explicitly set out in the claims.

It is also noted herein that while the above describes example embodiments of the invention, these descriptions should not be viewed in a limiting sense. Rather, there are several variations and modifications which may be made without departing from the scope of the present invention as defined in the appended claims.

What is claimed is:

1. A method comprising:
receiving an indication of a size for a virtual keyboard;
determining, based at least in part on the size, a layout for a virtual keyboard; and
causing the display of a virtual keyboard according to the layout.

2. The method of claim 1, wherein the indication comprises one of a user input and an indication of a user input.

3. The method of claim 2, wherein the user input is one of a pinch-zoom or reverse-pinch-zoom touch gesture.

4. The method of claim 1, further comprising:
generating the indication automatically.

5. The method of claim 4, wherein:
causing the display of the virtual keyboard comprises causing the display of the keyboard on a display; and
generating the indication automatically comprises basing generating the indication on content to be displayed with the virtual keyboard.

6. The method of claim 1, wherein determining a layout comprises selecting a layout from plurality of predetermined layouts.

7. The method of claim 6, further comprising:
determining that the size lies within a predetermined range of possible sizes, said predetermined range being associated with a particular one of the plurality of predetermined layouts, and wherein:
selecting a layout comprises selecting a layout with which the range is associated.

8. The method of claim 6, wherein determining a layout further comprises:
transforming the selected layout, based on the size.

9. The method of claim 8, wherein the transformation comprises stretching.

10. The method of claim 8, wherein the transformation comprises centering.

11. The method of claim 1, wherein determining a layout comprises:
dynamically generating a layout; and
selecting the dynamically-generated layout.

12. The method of claim 1, wherein:
a virtual keyboard is being caused to be displayed before the indication is received;
the indication of the size is relative to the displayed virtual keyboard; and
causing the display of the virtual keyboard according to the layout comprises causing the display of a new virtual keyboard based on the layout.

13. The method of claim 12, wherein the size is a scaling factor relative to the displayed virtual keyboard.

14. The method of claim 12, wherein the layout comprises a rearrangement of keys of the current keyboard.

15. The method of claim 1, wherein:
the size comprises an indication of the shape of an area; and
the layout is determined based on the shape of the area.

16. Apparatus comprising:
a processor; and
memory including computer program code,
the memory and the computer program code configured to, working with the processor, cause the apparatus to perform at least the following:
receive an indication of a size for a virtual keyboard;
determine, based at least in part on the size, a layout for a virtual keyboard; and
cause the display of a virtual keyboard according to the layout.

17. The apparatus of claim 16, being a mobile telephone.

18. The apparatus of claim 16, being a tablet computing device.

19. The apparatus of claim 16, further comprising the display.

20. A computer program product comprising a computer-readable medium bearing computer program code embodied therein for use with a computer, the computer program code comprising:
code for receiving an indication of a size for a virtual keyboard;
code for determining, based at least in part on the size, a layout for a virtual keyboard; and
code for causing the display of a virtual keyboard according to the layout.
